(19) United States
(12) Patent Application Publication
(10) Pub. No.: US 2003/0182877 A1
(43) Pub. Date: Oct. 2, 2003

(54) Window well structure

(76) Inventor: Dan Worth, Sandy, UT (US)

Correspondence Address: KARL R CANNON, PO BOX 1909, SANDY, UT, 84091, US

(21) Appl. No.: 10/109,403

(22) Filed: Mar. 27, 2002

(51) Int. Cl. E06B 5/02; E04F 17/06

(52) U.S. Cl. 52/107

(57) ABSTRACT

A window well for surrounding an open space contiguous to a building window located partly or completely below the ground surface. The window well is formed of a body having an interior wall, an exterior wall and a core material. The interior wall provides a smooth surface to which a design or paint may be applied so that the window well has an aesthetically pleasing appearance as viewed from a position inside the building. The core material provides insulation to the window well so that the window well may be covered to inhibit heat from escaping through the window. The window well is constructed so as to have low density, and high deflection and elastic memory capabilities.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

1. The Field of the Invention.

The present invention relates generally to window well structures, and more particularly, but not entirely, to window wells having aesthetic differential structural construction.

2. Description of Related Art.

It is common practice to provide window wells for below grade windows to allow more light to enter the window. In general, window wells are structures which surround windows located partly or completely below the ground surface to exclude earthen material from the window area and allow light to shine through the window. This makes basement spaces more desirable and also provides an areaway to allow exiting the basement in the event of an emergency.

Window wells are typically made of corrugated metal or cementitious materials. For example, U.S. Pat. No. 2,308,131 (granted Jan. 12, 1943 to Wellnitz) discloses a light well lining made of a plurality of pre-cast cementitious blocks. The cementitious blocks are stacked vertically and have inner ends formed for insertion in a building wall to form a cantilever extension of the building wall. The cementitious blocks are heavy and rigid which requires increased labor to assemble the window well in place. Also, the cementitious blocks do not provide an aesthetic appearance when viewed through the window from inside the building.

U.S. Pat. No. 3,844,076 (granted Oct. 29, 1974 to Schock) discloses a prefabricated basement window shield made of thin wall construction. The prefabricated basement window shield has a three dimensional curvature which allows the thin wall construction. However, the thin wall construction does not provide a significant insulation barrier. Therefore, the window well cannot be insulated from the weather by merely covering the top of the shield. Also, the basement window shield does not provide an aesthetic appearance when viewed through the window.

U.S. Pat. No. 5,881,503 (granted Mar. 16, 1999 to Eichelberger) discloses a decorative window well having a plurality of planters coupled to the window well for supporting plants. However, maintaining the plants may be laborious. Furthermore, the window well does not provide insulation for preventing the outside temperatures from entering the window area.

In view of the foregoing state of the art, it would be an advancement in the art to provide a window well structure which is simple in design and manufacture, and which has an aesthetically pleasing appearance. It would be a further advancement in the art to provide a window well structure which provides insulation from exterior temperatures, which is light in weight, which is flexible and which has an elastic memory.

The prior art is thus characterized by several disadvantages that are addressed by the present invention. The present invention minimizes, and in some aspects eliminates, the above-mentioned failures, and other problems, by utilizing the methods and structural features described herein.

### BRIEF DESCRIPTION OF THE DRAWINGS

The above and other objects, features and advantages of the invention will become apparent from a consideration of the subsequent detailed description presented in connection with the accompanying drawings in which:

FIG. 1 is a perspective view of a house having a window below the ground surface and a window well in accordance with the principles of the present invention.

FIG. 2 is a perspective view of a window well structure in accordance with the principles of the present invention.

### DETAILED DESCRIPTION OF THE INVENTION

For the purposes of promoting an understanding of the principles in accordance with the invention, reference will now be made to the embodiments illustrated in the drawings and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would normally occur to one skilled in the relevant art and having possession of this disclosure, are to be considered within the scope of the invention claimed.

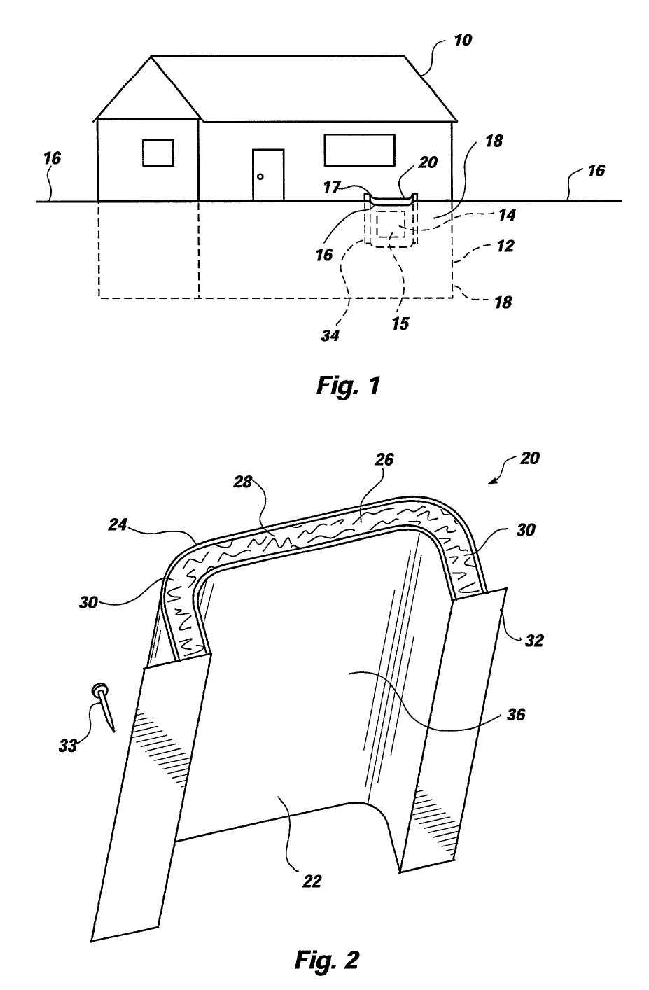

Referring now to FIG. 1, a building or house 10 having a basement 12 is shown. A basement window 14 is shown in a window space 15 below the ground surface 16. A window well 20 of the present invention can be attached to support walls 18 of the house 10 so as to surround an open space 17 contiguous to the window 14 residing in the window space 15 to exclude earthen material from the open space 17 and allow light to shine through the window 14. Although the window 14 is shown completely below the ground surface 16, those skilled in the art will appreciate that the window well 20 of the present invention may also be used in applications where the window 14 is not completely below the ground surface 16.

The window well 20 can have a window well body having a front wall segment 28 and two opposing side wall segments 30 extending transversely from the front wall segment 28. At least a portion of the side wall segments 30 can be spaced apart by a distance that is greater than a width of the window space 15 so that the window well 20 can be attached to the support walls 18 with the window 14 located between the side wall segments 30. The window well 20 may be attached to the support wall 18 by attachment means 32 for attaching the two opposing side wall segments 30 to side locations 34 adjacent the window space. The attachment means 32 can include a flange having a planar surface which abuts against the support wall 18. The flange may then be connected to the support wall 18 by, for example, adhesives or nails, screws, or bolts, as represented at 33. The pressure of the earthen material may also serve to maintain the window well 20 against the support wall 18. It will be appreciated by those skilled in the art that other attachment means may be used within the scope of the present invention. The window well 20 can be attached such that the side locations 34 residing outside of a perimeter of the window space 15 and on opposing sides of the window space 15, the window well body and the window 14 cooperatively enclose the open space 17 when the two opposing side wall segments 30 are attached to the side locations 34.

The front wall segment 28 and the side wall segments 30 of the window well 20 each can comprise a differential structure having at least two layers differing in hardness and stiffness. The window well 20 can include an interior wall 22, an exterior wall 24, and a core 26 which cooperatively define a single body having a one-piece unitary core. The interior wall 22 and the exterior wall 24 can be constructed to be harder and stiffer than the core 26. The interior wall 22 can be constructed of a material such as fiberglass which has a smooth surface and can be painted in an aesthetically pleasing manner to be viewed from within the house 10. The core 26 can be constructed from a material with good insulation properties so that a cover may be placed over the window well 20 to inhibit heat from escaping through the window 14. Also, the core 26 can have characteristics which enable the core 26 to be placed between the interior wall 22 and the exterior wall 24, such as expanded polystyrene. However, as those skilled in the art will appreciate, the core 26 may be made of different materials within the scope of the present invention.

The thickness of the window well 20 allows for multiple advantages such as providing adequate bulk for insulating the window and providing structural support, as well as being thin enough to be easily handled. The thickness of the window well 20 can be within a range of between ¾ to 2.0 inches. The window well 20 can have a thickness of approximately 1.0 inch. The thickness of the interior wall 22 and the exterior wall 24 may also vary within the scope of the present invention, having a preferred range of between 0.05 to 0.25 inches.

The interior wall 22, exterior wall 24, and core 26 together form the window well body which is light in weight to facilitate handling and installation. The density of the window well body can be less than 125 pounds per cubic foot (pcf). The density of the window well body can be less than 25-50 pcf. The low density characteristics of the present window well is an improvement over prior art window wells such as those made with concrete, which may have a density of approximately 150 pcf, or metals which may have even higher densities. It will be appreciated by those skilled in the art that the density of the window well may vary within the scope of the present invention. However, the density of the present inventive window well 20 is lower than the prior art window wells. For example, the thickness of the interior wall 22 and the exterior wall 24 may be designed to be small in comparison to the thickness of the core 26 such that a majority of the volume of the window well 20 may be comprised of the core 26. The core 26 may have a low density compared to the interior wall 22 and the exterior wall 24 such that the density of the window well 20 may be very low in comparison to the prior art window wells.

Also, the window well 20 of the present invention is versatile in that it is constructed so as to allow deflection. The deflection characteristics of the window well 20 allows the window well 20 to be installed without the need for exact measurements. Furthermore, the window well 20 is constructed and arranged to possess elastic memory. This characteristic of the window well 20 is beneficial in that the window well 20 maintains an aesthetically pleasing appearance without denting or cracking, unlike the prior art window wells. The window well 20 has the ability to deflect and return to its original position so that damage resulting from handling and installation is less likely.

The window well 20 can be manufactured by creating molds of the desired dimensions for the interior wall 22 and exterior wall 24. A gel coat may be sprayed on the molds and layers of composite mesh placed on the molds for the desired thickness of the interior wall 22 and the exterior wall 24. Resin may be poured on the layers of composite mesh and allowed to cure. The interior wall 22 and exterior wall 24 may then be removed from the molds and held together with a device such as a holding jig. A hollow cavity is defined by the interior wall 22 and the exterior wall 24 which may be filled with a foam material to form the core 26. The window well 20 is characterized by a single body having layers defined by the interior wall 22, the exterior wall 24, and the core 26. It will be apparent to those skilled in the art that other methods of forming the interior wall 22 and exterior wall 24 and core 26 may be used within the scope of the present invention.

The interior wall 22 can be constructed so as to be smooth, unlike the undulating surfaces on window wells made of corrugated metal, or the coarse surfaces of cementitious window wells. The smooth surface of the interior wall 22 facilitates the application of an aesthetic representation or design 36. Design 36 may be placed on the interior wall 22 by painting the interior wall 22, or covering the interior wall 22 with a picture for example. Also, the interior wall 22 may be made using dyes of various colors to improve the appearance of the window well. As those skilled in the art will appreciate, designs may be placed on the interior wall 22 using other techniques within the scope of the present invention. The design 36 may be viewed from within the house 10 to improve the appearance of the window well 20.

In accordance with the features and combinations described above, a preferred method of forming a window well 20 for surrounding an open space 17 contiguous to a window 14 residing in a window space 15 includes the steps of:

(A) forming an interior wall 22 of the window well 20;

(B) forming an exterior wall 24 of the window well 20;

(C) joining the interior wall 22 of the window well 20 and the exterior wall 24 of the window well 20 to form a window well body, the window well body having a front wall segment 28 and two opposing side wall segments 30 extending transversely from the front wall segment 28. At least a portion of the side wall segments are spaced apart by a distance that is greater than a width of the window space 15; and

(D) placing a core material 26 between the interior wall 22 of the window well 20 and the exterior wall 24 of the window well 20.

It will be appreciated that the structure and apparatus disclosed herein is merely one example of attachment means for attaching the two opposing side wall segments to side locations adjacent the window space, and it should be appreciated that any structure, apparatus or system for attaching which performs functions the same as, or equivalent to, those disclosed herein are intended to fall within the scope of attachment means for attaching the two opposing side wall segments to side locations adjacent the window space, including those structures, apparatus or systems for attaching which are presently known, or which may become available in the future. Anything which functions the same as, or equivalently to, attachment means for attaching the two opposing side wall segments to side locations adjacent the window space falls within the scope of this element.

In view of the foregoing, it will be appreciated that the present invention provides a window well structure which is simple in design and manufacture, and which has an aesthetically pleasing appearance. The present invention also provides a window well structure which allows insulation from exterior temperatures, which is light in weight, which is flexible and which has an elastic memory.

It is a feature of the present invention to provide a window well structure which is simple in design and manufacture.

It is another feature of the present invention to provide such a window well structure which provides insulation from the exterior temperatures.

It is a further feature of the present invention, in accordance with one aspect thereof, to provide window well structure which has an aesthetically pleasing appearance.

It is an additional feature of the invention, in accordance with one aspect thereof, to provide a window well structure which is light in weight.

It is another feature of the present invention to provide a window well structure which is flexible and has an elastic memory.

Additional features and advantages of the invention will be apparent from the above description, or may be learned by the practice of the invention without undue experimentation. The features and advantages of the invention may be realized and obtained by means of the instruments and combinations particularly pointed out in the appended claims.

It is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been shown in the drawings and fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A window well for surrounding an open space contiguous to a window residing in a window space, said window well comprising:
a window well body having a front wall segment and two opposing side wall segments extending transversely from said front wall segment, wherein at least a portion of said side wall segments are spaced apart by a distance that is greater than a width of the window space; and
attachment means for attaching the two opposing side wall segments to side locations adjacent the window space, respectively, such that (i) said side locations reside outside of a perimeter of the window space and on opposing sides of said window space, and (ii) the window well body and the window cooperatively enclose the open space when the two opposing side wall segments are attached to the side locations;
wherein the front wall segment and the side wall segments of the window well each comprise a differential structure having at least two layers differing in hardness and stiffness.

2. The window well of claim 1 wherein the front wall segment and the two side wall segments of the window well body cooperatively define a single body having a one-piece unitary core.

3. The window well of claim 1 wherein the at least two layers comprises two external layers and an internal core layer.

4. The window well of claim 3 wherein the hardness and stiffness of the two external layers is greater than the hardness and stiffness of the internal core layer.

5. The window well of claim 3 wherein a thickness of the internal core layer is greater than a thickness of the two external layers.

6. The window well of claim 3 wherein the internal core layer has greater insulation properties than the external layers.

7. The window well of claim 1 wherein the window well body has a thickness in a range of between ¾ and 2 inches.

8. The window well of claim 1 wherein the window well body comprises a smooth surface.

9. The window well of claim 8 further comprising a decorative design applied to said smooth surface.

10. The window well of claim 9 wherein said decorative design comprises paint applied to said smooth surface.

11. The window well of claim 1 wherein said attachment means comprises a flange on said window well.

12. The window well of claim 11 wherein the attachment means further comprises one of the group consisting of nails, bolts, screws, and adhesive.

13. The window well of claim 3 wherein the exterior layers are made of a composite mesh.

14. The window well of claim 1 wherein the window well body has a density that is less than 50 pcf.

15. A window well for surrounding an open space contiguous to a window residing in a window space, said window well comprising:
a window well body having a front wall segment and two opposing side wall segments extending transversely from said front wall segment, wherein at least a portion of said side wall segments are spaced apart by a distance that is greater than a width of the window space; and
attachment means for attaching the two opposing side wall segments to side locations adjacent the window space, respectively, such that (i) said side locations reside outside of a perimeter of the window space and on opposing sides of said window space, and (ii) the window well body and the window cooperatively enclose the open space when the two opposing side wall segments are attached to the side locations;
wherein the window well body has a density that is less than 125 pcf.

16. The window well of claim 15 wherein the window well body has a density that is less than 75 pcf.

17. The window well of claim 16 wherein the window well body has a density that is less than 25 pcf.

18. The window well of claim 15 wherein the window well body comprises a differential structure having at least two layers differing in hardness and stiffness.

19. The window well of claim 18 wherein the at least two layers comprises two external layers and an internal core layer.

20. The window well of claim 19 wherein the hardness and stiffness of the two external layers is greater than the hardness and stiffness of the internal core layer.

21. The window well of claim 19 wherein a thickness of the internal core layer is greater than a thickness of the two external layers.

22. The window well of claim 19 wherein the internal core layer has greater insulation properties than the external layers.

23. The window well of claim 15 wherein the window well body has a thickness in a range of between ¾ and 2 inches.

24. The window well of claim 15 wherein the window well body comprises a smooth surface.

25. The window well of claim 24 further comprising a decorative design applied to said smooth surface.

26. The window well of claim 15 wherein said attachment means comprises a flange on said window well.

27. The window well of claim 26 wherein the attachment means further comprises one of the group consisting of nails, bolts, screws, and adhesive.

28. The window well of claim 19 wherein the exterior layers are made of a composite mesh.

29. A window well for surrounding an open space contiguous to a window residing in a window space, said window well comprising:
a window well body having a front wall segment and two opposing side wall segments extending transversely from said front wall segment, wherein at least a portion of said side wall segments are spaced apart by a distance that is greater than a width of the window space; and
attachment means for attaching the two opposing side wall segments to side locations adjacent the window space, respectively, such that (i) said side locations reside outside of a perimeter of the window space and on opposing sides of said window space, and (ii) the window well body and the window cooperatively enclose the open space when the two opposing side wall segments are attached to the side locations;
wherein the front wall segment and the side wall segments of the window well each have a thickness within a range of between ¾ and 2 inches.

30. The window well of claim 29 wherein the front and side wall segments each have a thickness of approximately one inch.

31. The window well of claim 29 wherein the window well body has a density that is less than 50 pcf.

32. The window well of claim 29 wherein the window well body comprises a differential structure having at least two layers differing in hardness and stiffness.

33. The window well of claim 32 wherein the at least two layers comprises two external layers and an internal core layer.

34. The window well of claim 33 wherein the hardness and stiffness of the two external layers is greater than the hardness and stiffness of the internal core layer.

35. The window well of claim 33 wherein a thickness of the internal core layer is greater than a thickness of the two external layers.

36. The window well of claim 33 wherein the external layers each have a thickness in a range of between 0.05 and 0.25 inches.

37. The window well of claim 29 wherein the window well body comprises a smooth surface.

38. The window well of claim 37 further comprising a decorative design applied to said smooth surface.

39. The window well of claim 29 wherein said attachment means comprises a flange on said window well.

40. The window well of claim 39 wherein the attachment means further comprises one of the group consisting of nails, bolts, screws, and adhesive.

41. The window well of claim 33 wherein the exterior layers are made of a composite mesh.

42. A window well for surrounding an open space contiguous to a window residing in a window space, said window well comprising:
a window well body having a front wall segment and two opposing side wall segments extending transversely from said front wall segment, wherein at least a portion of said side wall segments are spaced apart by a distance that is greater than a width of the window space; and
attachment means for attaching the two opposing side wall segments to side locations adjacent the window space, respectively, such that (i) said side locations reside outside of a perimeter of the window space and on opposing sides of said window space, and (ii) the window well body and the window cooperatively enclose the open space when the two opposing side wall segments are attached to the side locations;
wherein the window well body further comprises a smooth surface to which an aesthetic appearance is applied.

43. The window well of claim 42 wherein the aesthetic appearance comprises a decorative design.

44. The window well of claim 42 wherein said aesthetic appearance comprises paint applied to said smooth surface.

45. The window well of claim 42 wherein said aesthetic appearance comprises a bright color.

46. The window well of claim 42 wherein the window well body has a density that is less than 50 pcf.

47. The window well of claim 42 wherein the window well body comprises a differential structure having at least two layers differing in hardness and stiffness.

48. The window well of claim 47 wherein the at least two layers comprises two external layers and an internal core layer.

49. The window well of claim 48 wherein the hardness and stiffness of the two external layers is greater than the hardness and stiffness of the internal core layer.

50. The window well of claim 48 wherein a thickness of the internal core layer is greater than a thickness of the two external layers.

51. The window well of claim 48 wherein the external layers each have a thickness in a range of between 0.05 and 0.25 inches.

52. The window well of claim 42 wherein the window well body has a thickness in a range of between ¾ and 2 inches.

53. The window well of claim 42 wherein said attachment means comprises a flange on said window well.

54. The window well of claim 53 wherein the attachment means further comprises one of the group consisting of nails, bolts, screws, and adhesive.

55. The window well of claim 48 wherein the exterior layers are made of a composite mesh.

56. A method of forming a window well for surrounding an open space contiguous to a window residing in a window space, said method comprising the steps of:
(A) forming an interior wall of said window well;
(B) forming an exterior wall of said window well;
(C) joining said interior wall of said window well and said exterior wall of said window well to form a window well body, said window well body having a front wall segment and two opposing side wall segments extending transversely from said front wall segment, wherein at least a portion of said side wall segments are spaced apart by a distance that is greater than a width of the window space; and
(D) placing a core material between said interior wall of said window well and said exterior wall of said window well.

57. The method of claim 56 further comprising placing a decorative design on the interior wall of said window well.

58. The method of claim 56 wherein step (A) and step (B) further comprise molding a composite mesh.

59. The method of claim 58 further comprising placing a resin on the composite mesh.

60. A method of forming a window well for surrounding an open space contiguous to a window residing in a window space, said method comprising:
(A) forming a window well body having a front wall segment and two opposing side wall segments extending transversely from said front wall segment, wherein at least a portion of said side wall segments are spaced apart by a distance that is greater than a width of the window space, and wherein said window well body defines a hollow cavity therein; and
(B) filling at least a portion of said hollow cavity of said window well body with a core material.

61. The method of claim 60 further comprising placing a decorative design on the front wall segment of said window well.

62. The method of claim 60 wherein step (A) further comprises molding said window well body from a composite mesh.

63. The method of claim 62 further comprising placing a resin on the composite mesh.

64. A method of covering a window residing in a window space, said method comprising the steps of:
enclosing an open space contiguous to said window with a window well, said window well having a hollow cavity surrounding said open space, at least a portion of said hollow cavity being filled with a core material.

65. The method of claim 64 further comprising placing a decorative design on said window well.

66. The method of claim 65 wherein placing the decorative design on the window well further comprises applying paint on a smooth surface of said window well.

67. The method of claim 64 further comprising placing an insulative cover over a top of said window well to protect said window from ambient conditions.

68. The method of claim 64 further comprising placing earthen material on an exterior side of said window well.

69. The method of claim 64 further comprising attaching opposing sides of said window well to side locations adjacent the window space.
